(19) United States
(12) Patent Application Publication
(10) Pub. No.: US 2025/0079440 A1
(43) Pub. Date: Mar. 6, 2025

(54) SOLID STATE LITHIUM-ION BATTERIES COMPRISING A NANOPOROUS SILICON ANODE

(71) Applicant: LEYDENJAR TECHNOLOGIES B.V., Leiden (NL)

(72) Inventors: Zhaolong LI, Delft (NL); Marnix WAGEMAKER, Delft (NL); Arjen DIDDEN, Leiden (NL); Joris MAAS, Leiden (NL); Rohan SIVARAJ, Leiden (NL); Ankit GOYAL, Leiden (NL); Bernette OOSTERLAKEN, Leiden (NL)

(73) Assignee: Leydenjar Technologies B.V., Leiden (NL)

(21) Appl. No.: 18/722,695

(22) PCT Filed: Dec. 22, 2022
(86) PCT No.: PCT/NL2022/050754

§ 371 Date: Jun. 21, 2024

(30) Foreign Application Priority Data
Dec. 23, 2021 (NL) 2030271

(51) Int. Cl. H01M 4/134; H01M 4/02; H01M 4/04; H01M 4/36; H01M 4/38; H01M 4/485; H01M 4/525; H01M 4/62; H01M 4/66; H01M 10/0525; H01M 10/0562

(52) U.S. Cl. CPC H01M 4/134; H01M 4/0404; H01M 4/0428; H01M 4/366; H01M 4/386; H01M 4/485; H01M 4/525; H01M 4/62; H01M 4/625; H01M 4/661; H01M 10/0525; H01M 10/0562; H01M 2004/021; H01M 2004/027; H01M 2004/028; H01M 2300/0068

(57) ABSTRACT

The present disclosure relates to a lithium-ion battery, comprising: a silicon anode comprising an essentially pure amorphous porous silicon film deposited onto a current collector, and comprising a plurality of columnar structures; an electrolyte layer comprising one or more solid components, and a cathode layer.

### FIELD

The present disclosure relates to lithium-ion batteries and more particularly to solid-state lithium-ion batteries comprising Silicon anodes.

### BACKGROUND

In recent years, with the continued spread of communication devices such as personal computers, video cameras, and portable telephones, high-density rechargeable lithium-ion batteries, are now common in all sorts of electronic devices. Despite their broad use, scientists believe that traditional Li-ion liquid electrolyte battery technology is already nearing its full potential and new types of batteries are needed. Yet further, lithium-ion batteries commercially available at present typically employ organic electrolytic solutions which contain combustible, flammable, and often toxic solvents. Therefore, there is a concern about the safety and operational temperature for the usage of lithium-ion batteries.

More recently, solid-state lithium batteries in which an electrolyte layer that is solid or semi-solid is used in place of the electrolytic solution and do not contain inflammable organic solvents, have found significant interest. Solid-state batteries are quite similar to that of a lithium-ion liquid electrolyte batteries, with the main difference being the use of an electrolyte that is solid or semi-solid in place of a liquid electrolyte.

Solid electrolytes known to date include organic and inorganic materials, such as oxides, sulfides, phosphates, polyethers, polyesters, nitrile-based, polysiloxane, polyurethane, and materials such as glass, ceramic, etc. can be used for this purpose. The performance of the battery depends on the type of electrolyte used, e.g. ceramics are more suitable for rigid battery systems due to their high elastic modulus, while low elastic moduli of polymers make them fit for flexible devices. More recently, sulfide based solid electrolyte materials have been described, for instance in US2020/0087155A1, and US2021/0143413A1. Also, silicon anodes with varying morphologies have been disclosed, e.g. silicon nanowires as shown in EP3876311.

However, one of the main obstacles restraining the improvement of lithium-based battery performance is the electrode/electrolyte interface, which is the key to battery performance, as it is the location where the electron and Li-ion combine and then get stored in the electrode, via intercalation, alloying, or simply as Li metal. Known solid electrolytes and electrode material combinations are prone to loss of lithium-ions during cycling, as new solid electrolyte interfaces form spontaneously. Furthermore, known anode materials are prone to swelling during battery performance, resulting in eventual loss of structural integrity.

Accordingly, it would be desirable to have a battery composition that alleviates one or more of the obstacles for solid state battery performance. Yet further, there is the need for an solid-state battery comprising an improved electrode material, with increased cycle life and/or cycle performance.

### SUMMARY

Accordingly, the present disclosure relates to a lithium-ion battery, comprising:
(i) a silicon anode comprising an essentially pure amorphous porous silicon film deposited onto a current collector, and comprising a plurality of columnar structures;
(ii) an electrolyte layer comprising one or more solid components, and
(iii) a cathode layer comprising a cathode active materials.

In a second aspect, the present disclosure further relates to processes for assembling a solid-state or semi-solid state battery based on the use of silicon anode, comprising (i) argyrodite sulfide-based solid electrolyte powder homogenously distribute on silicon anode layer, and compress under the pressure, (ii) after the cathode mixed powder is homogenously distributed on the top of formed layer at prior step, (iii) the aluminium current collector is placed on the top of cathode mixed powder, (iv) a pressure is applied to compress all the battery materials to form a solid-state battery.

The present disclosure also relates to processes for assembling a multiple stack solid-state battery, comprising (i) distributing argyrodite sulfide-based electrolyte powder homogenously on a silicon anode layer, (ii) distributing cathode mixed powder homogenously on the sulfide-based electrolyte powder, (iii) placing an aluminium current collector on the cathode mixed powder, (iv) distributing the cathode mixed powder is homogenously on the other side of aluminium collector, after distributing a argyrodite sulfide-based solid electrolyte powder homogenously on the cathode mixed powder, (v) a double side deposited silicon anode is applied on the argyrodite sulfide-based solid electrolyte powder, (vi) by repeating the process of (ii)˜(v), (iv) finally, a pressure is applied to compress the above components, including the electrolyte powder and silicon anode layer, to form a multiple stack solid-state battery.

It is yet a further object to provide a battery comprising an electrolyte, a cathode, a separator and the composite material according to the invention or the composite material obtainable according to the method according to the invention.

In a further aspect, the invention provides a use of the composite material according to the invention or the composite material obtainable according to the method according to the invention in a battery or for the manufacture of a battery.

In a further aspect the invention relates to an anode material for use in a battery, preferably a solid state battery, comprising (i) a silicon anode comprising an essentially pure amorphous porous silicon film deposited onto a current collector, and comprising a plurality of columnar structures; wherein the plurality of columnar structures are frustoconical shaped structures having an average cone angle α in the range of from 65° to 85°, preferably of from 70° to 80°, converging from a closed anchoring point at the basal plane, and extending upwardly therefrom.

### BRIEF DESCRIPTION OF THE DRAWINGS

The present disclosure may be understood for the present invention reference to the following figures. The example figures should not be considered limiting, instead they should be considered for explaining and understanding purpose.

FIG. 1A illustrates a cross section of an example of single sided silicon anode in an all-solid-state battery. In FIG. 1A, item 1 represents the copper foil as anode current collector, item 2 represents the silicon film, item 3 represents the solid-state electrolyte layer, item 4 represents the cathode mixture layer, and item 5 represents the cathode current collector, which typically may be an aluminium foil. Items 1 and 2 should be considered as a unit in this invention.

FIG. 1B illustrates a cross section of an example of double-sided silicon anode in an all-solid-state battery. The items 1 to 5 are described the same as in FIG. 1A.

FIGS. 2A and 2B show an example of the top and the cross-section SEM images of the single-sided deposited silicon anode.

FIG. 2C shows an example of the cross-section SEM images of a double-sided deposited silicon anode. Of note in all figures are the columnar structures, which may include essentially parallel columnar structures, but also may be arranged so that an angle is formed between the basal plane and the columnar central axis. Such shapes are typically also referred to as stacked cones, ice cream cones, or stacked cone structures. The diameter of the as stacked cones, and/or ice cream cones can range of from 1 to 10 μm. Despite these structural variations, many types of silicone anode materials are suitable for use in the compositions of the present invention.

FIGS. 3A, B, C, and D shows three examples of the electrochemical rate performance of a single side silicon anode with different mass loading in a solid-state half-cell, wherein an argyrodite sulfide based Li₆PS₅Cl is used as solid electrolyte layer, and the lithium and indium metal foil are used as counter electrodes. In these FIGS. 3A, B, C, and D, the rate performance is illustrated of Si anodes with different mass loading, and 1 C rate is defined as 3000 mAh/g based on Si mass.

The indium metal is used to avoid to parasitic reaction between lithium metal and solid electrolyte Li₆PS₅Cl. The all-solid-state half-cell is tested to verify the feasibility of silicon film as an anode in the all-solid-state battery. Quite apparently, the example results show that the invented silicon anode perform an excellent lithium-ion host ability in a solid-state battery.

FIG. 4 shows an example of the electrochemical cycle performance of a single side silicon anode in an all-solid-state half-cell, where the argyrodite sulfide based Li₆PS₅Cl is used as solid electrolyte layer, and the lithium and indium metal foil are used as counter electrodes.

FIGS. 5A and B shows two examples of the electrochemical rate performance of a single-sided silicon anode according to the invention in all all-solid-state batteries, where the argyrodite sulfide based Li₆PS₅Cl is used as solid electrolyte layer, and the lithium nickel manganese cobalt oxide mixture (LiNi_{0.6}Mn_{0.2}Co_{0.2}O₂, NMC622 cathode active powder mixed with Li₆PS₅Cl, and conductive carbon powder) is used as cathode.

FIG. 6 shows an example of the electrochemical cycle performance of a single-sided silicon anode according to the invention in all all-solid-state batteries, where the argyrodite sulfide based Li₆PS₅Cl is used as solid electrolyte layer, and the lithium nickel manganese cobalt oxide mixture (LiNi_{0.6}Mn_{0.2}Co_{0.2}O₂, NMC622 cathode active powder mixed with Li₆PS₅Cl, and conductive carbon powder) is used as cathode.

FIG. 7 shows an example of the electrochemistry cycle performance of a single-sided silicon anode according to the invention in all-solid-state batteries, where the argyrodite sulfide based Li6PS5Cl is used as solid electrolyte layer, and the lithium niobium oxide (LiNbO₃) coated lithium nickel manganese cobalt oxide (LiNbO3 coated LiNi_{0.8}Mn_{0.1}Co_{0.1}O₂, NMC811 cathode active powder) mixed with Li6PS5Cl power is used as cathode (the mass proportion of NMC811:Li6PSCl5 in the example is 70:30 wt. %)

In this example of an all-solid-state battery, the argyrodite sulfide based Li₆PS₅Cl was used as solid electrolyte layer, and LiOH-treated LiNbO₃-coated NMC811, mixed with Li₆PSCl₅ in a mass proportion of 70:30 wt. % was used as the cathode.

FIG. 8 shows an example of the electrochemistry cycle performance of a single-sided silicon anode according to the invention in all-solid-state batteries. Herein, as the cathode active material LiNbO₃ coated NMC811 was further treated by using LiOH, by simply grinding and mixing LiOH powder and NMC811 powder in a certain mass proportion, and then the mixture is further annealed at certain temperature in air. In this example, the mass proportion of LiOH:LiNbO₃ coated NMC811 was 5:95 wt. %, afterwards the mixture was annealed at 750° C. for 10 hours in contact with air.

FIGS. 9A and 9B show schematically a silicon anode material according to the invention for use in lithium batteries. Herein, the anode structures are visible before (A), and post lithiation (B). FIGS. 9C and 9D show SEM images showing this effect on actually tested materials. On the current collector (1), nodules are added (2). In our case this is a copper foil with copper nodules, but the idea can be applicable for different substrates.

FIG. 9E illustrates the distances and sizes of the structures, defining the average gap (a) between nodules; the angle of initial growth is perpendicular to the basal plane, so a starting average value for b (representing the outer cone angle ß); the angle γ at the top end of a columnar structure; the average height of the structure s is preferably in the range of from 0.25 μm to 3 μm. Hereby it is noted that the height of pillar is dependent on mass loading, and preferably about 1.5 mg/cm²=10 μm.

The average radius of a columnar structure or nodule at its widest point is preferably in the range of from 0.125 μm to 1 μm. The average radius a preferably of the dome shaped top of a columnar structure is preferably in the range of from 0.1 μm to 5 μm.

### DETAILED DESCRIPTION

Unless otherwise defined, all technical and scientific terms herein have the same meaning as commonly understood by one of ordinary skill in the art to which this invention belongs. The terminology used in the description of the invention herein is for the purpose of describing embodiments only and is not intended to be limiting of the invention.

The term “all-solid-state battery” as used herein, refers to a silicon anode, a mixed cathode, and an argyrodite solid electrolyte layer between.

The term “semi-solid state battery” refers to a silicon anode, a mixed cathode, and a semi-solid solid electrolyte layer between, wherein the electrolyte comprises solid components, e.g. in a gel or soggy-sand configuration.

The term “silicon anode” as used herein, refers to a silicon film that is directly deposited on one side or on both side of copper current collector.

The term “silicon film” as used herein, refers to an amorphous porous silicon structure consisting essentially of silicon, with a plurality of columns and nano-sized primary particles in the silicon columns produced by plasma-enhanced-chemical-vapor deposition (PECVD) method.

The term “silicon film” herein refers to a layer that consist of silicon, hydrogenated silicon or doped silicon that is either amorphous, or crystalline, or a mixture of amorphous and crystalline.

The anode material preferably is a composite electrode material comprising:
i) a current collector material layer; and
ii) at least a first silicon layer positioned on the current collector material layer.

The silicon film or layer may comprise several different layers, and preferably has a thickness of 5 to 50 μm with a mass loading of 0.1-4 mg/cm². It is noted that the silicon film thickness and mass loading herein described is not intended to be limited, and it can be thinner and lighter or thicker and heavier.

The term “amorphous silicon” herein refers to a comprising paracrystalline silicon that can be defined as amorphous silicon comprising a fraction of nanocrystalline silicon. This fraction may be up to about 30% of the nanostructured silicon layer.

The optional first silicon semicollector material layer and a surface area of one layer is in direct contact with a surface area of the other layer.

An optional first silicon layer according to the invention preferably has a low porosity, thereby enabling an increased attachment of the silicon active material to the current collector material layer while also serving as a substrate for increased attachment of the second silicon layer. A high porosity of the optional first silicon layer may hence reduce the increased attachment. Preferably, the optional first silicon layer according to the invention has a porosity of less than 30, 20 or 15%, more preferably of less than 10, 9, 8, 7 or 6%, most preferably of less than 5, 4, 3, 2 or 1%.

The porosity of a silicon layer is commonly determined by the Barrett-Joyner-Halenda (BJH) method pursuant to ISO 15901-2:2006. ISO 15901-2:2006 describes a method for the evaluation of porosity and pore size distribution by gas adsorption, which is explained in more detail below. However, the silicon layers according to the invention may comprise multiple layers of different porosities.

Production of a second silicon layer may require the optional first silicon layer as a substrate for its formation and specific structure. After production of the composite electrode material, multiple silicon layers cannot reliably be separated without damaging or fracturing the layers and thereby altering their porosity. Therefore, the BJH method (pursuant to ISO 15901-2:2006) is less suitable for determination of the exact porosity of each of the individual silicon layers of the composite electrode material when more than one silicon layer is present.

Analysis of cross-sectional electron microscopy images of the produced composite electrode material is preferred for determination of the porosity of the individual silicon layers of the composite material according to the invention. The analysis can be done by visual inspection of the images or automatically by using an image analysis algorithm that is configured to discern silicon material from void space in the silicon layers via for example a difference in pixel intensities using a suitable threshold. Thus, according to the invention, porosity of a silicon layer, preferably the optional first layer, the second or additional layer(s), more preferably the optional first layer or the additional layer(s), is preferably determined by electron microscopy.

Alternatively, analysis of cross-sectional electron microscopy images of the composite electrode material according to the invention can advantageously be combined with the BJH method pursuant to ISO 15901-2:2006 for determining the porosity of multiple silicon layers, e.g. a first silicon layer and a second silicon layer according to the invention.

Data of the results of the BJH method can be combined with an image analysis algorithm. For example, the BJH method is first used to measure the porosity of a composite electrode according to the invention comprising multiple silicon layers. Next, the algorithm can determine the porosity of a silicon layer by analysing cross-sectional electron microscopy images of the composite electrode according to the invention comprising multiple silicon layers, after which the determined porosity is compared to historical data of the BJH method that were used to determine specific porosities of a single silicon layer. Then the algorithm can use the historical BJH data of a single layer to determine the porosity of the multiple silicon layers while also using the most recent BJH data.

The at least second silicon layer according to the invention is present or positioned on either the optional first silicon layer or the current collector material layer and a surface area of one layer is in direct contact with a surface area of the other layer.

The at least second silicon layer according to the invention has a higher porosity than the optional first layer. When the first layer is not present the second layer can have any porosity, but less than 80%. A high porosity enables more volume expansion of the silicon active material, which results in less stress and less risk of fractures during lithiation and dilithiation cycles. In addition, lithium-ion transport in the electrolyte phase is increased by a highly porous structure of the silicon layer.

Preferably, the second silicon layer according to the invention has a porosity of more than 1, 2, 3, 4, 5, 6, 7, 8, 9 or 10%, more preferably of more than 5, 6, 7 or 8%. A sufficient amount of silicon active material needs to be present for energy storage. Thus, according to the invention the second silicon layer preferably has a porosity of from 5, 10 or 15 to 20, 25, 30, 35, 40, 45, 50, 55, 60, 70 or 80%, more preferably of from 6, 7, 8, 9 or 10 to 18, 20, 25 or 30%, most preferably of from 6 or 8 to 18%.

The second silicon layer according to the invention preferably has a porosity ranging from a porosity higher than the porosity of the optional first silicon layer to a porosity of less than 80, 70, 60, 55, 50, 45, 40, 35 or 30%, more preferably of less than 30, 29, 28, 27, 26, 25, 24, 23, 22, 21, 20 or 19%, most preferably of less than 20 or 19%.

The porosity of the second silicon layer according to the invention can be determined by electron microscopy or by the BJH method pursuant to ISO 15901-2:2006. The BJH method pursuant to ISO 15901-2:2006 has the advantage of being a faster and less cumbersome method of analysis than electron microscopy. The specific porosity percentages of the second layer or additional layer(s) according to the invention can be determined by the BJH method pursuant to ISO 15901-2:2006. Thus, porosity of the second or an additional silicon layer according to the invention can be determined by the BJH method pursuant to ISO 15901-2:2006, which is explained in more detail below.

Porosity and (average) pore size of the material according to the invention are preferably determined according to the method specified by the ISO (International Organization for Standardization) standard: ISO 15901-2:2006 “Pore size distribution and porosity of solid materials by mercury porosimetry and gas adsorption—Part 2: Analysis of mesopores and macropores by gas adsorption” using nitrogen gas. Specific surface area of the material according to the invention is preferably determined according to the method specified by the ISO standard: ISO 9277:2010 “Determination of the specific surface area of solids by gas adsorption—BET method” using nitrogen gas. Briefly, for both ISO methods, a N2 adsorption-isotherm is measured at about −196° C. (liquid nitrogen temperature).

According to the calculation method of Barrett-Joyner-Halenda (Barrett, E. P.; Joyner, L. G.; Halenda, P. P. (1951), “The Determination of Pore Volume and Area Distributions in Porous Substances. I. Computations from Nitrogen Isotherms”, Journal of the American Chemical Society, 73 (1): 373-380) the pore size and pore volume can be determined. Specific surface area can be determined from the same isotherm according to the calculation method of Brunauer-Emmett-Teller (Brunauer, S.; Emmett, P. H.; Teller, E. (1938), “Adsorption of Gases in Multimolecular Layers”, Journal of the American Chemical Society, 60 (2): 309-319). Both calculation methods are well-known in the art. A brief experimental test method to determine the isotherm can be described as follows: a test sample is dried at a high temperature and under an inert atmosphere. The sample is then placed in the measuring apparatus. Next, the sample is brought under vacuum and cooled using liquid nitrogen. The sample is held at liquid nitrogen temperature during recording of the isotherm.

The term ‘void space’ or ‘void structure’ herein is understood to mean an area in a silicon layer that does not contain a component of the composite electrode. The void space or structure is empty or filled with atmospheric (liquid or gaseous) fluid. The void space or structure provides an area for the silicon to expand into during use of the composite electrode material. Moreover, electrolyte or electrolyte comprising lithium (ions) can be present in the void space or structure during use of the composite electrode material in a battery. Determination of the dimensions of the void space or structure is preferably performed by analysis of cross-sectional images of the layers or material by electron microscopy, wherein the cross section is perpendicular to the surface plane of the current collector material. A dimension of a void space or structure is preferably determined over a continuous area of the void space or structure by analysis of cross-sectional images of the layers or material.

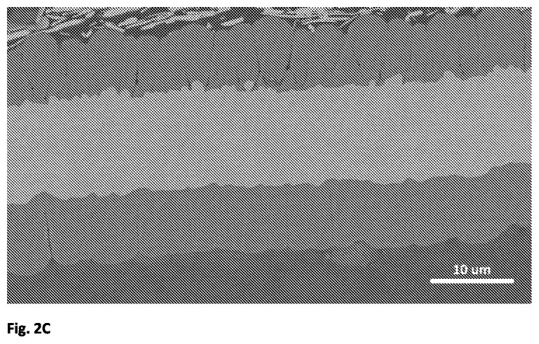

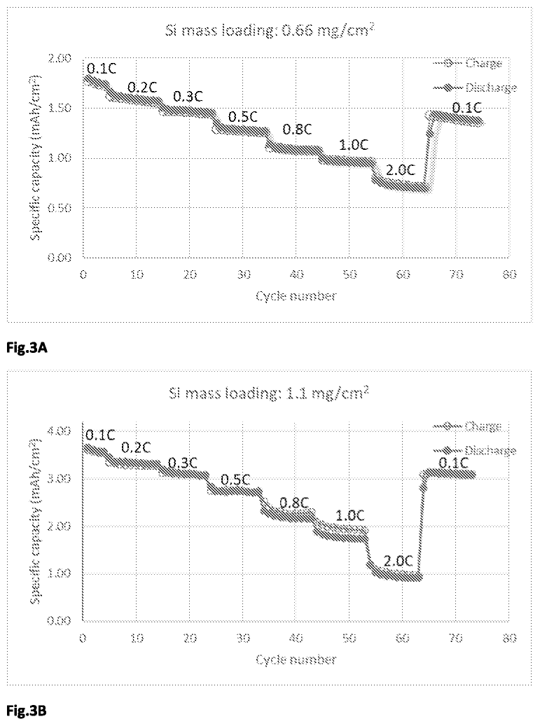

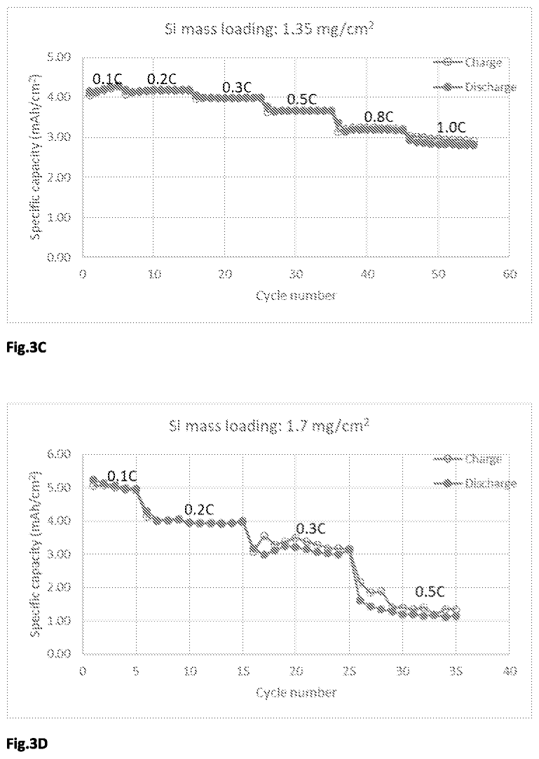

The at least second silicon layer according to the invention preferably comprises a plurality of void structures having a mean width of from 1 to 10 nm. The additional silicon layer according to the invention can comprise a plurality of void structures having a mean width of from 1 to 10 nm. The presence of void structures of the additional silicon layer depends on the porosity of the additional silicon layer. Preferably, the void structures comprise elongate tubular-like structures, channels, and/or a plurality of interlinked pores. The void structures mostly have an orientation with a substantially diagonal to perpendicular angle to the surface plane of the current collector material as can be determined from a cross-sectional electron microscope image perpendicular to the surface plane of the current collector material. Preferably, the void structures according to the invention have a mean width of from 1, 2, 3, 4 or 5 to 6, 7, 8, 9 or 10 nm. The void structures according to the invention can have a length of up to the thickness of the silicon layer. Their width can vary along their length. Typical void structures are exemplified in FIGS. 2 and 3.

Preferably, the anode material according to the invention comprises an additional silicon layer present on or positioned on top of the second silicon layer, and optionally one or more additional silicon layers each in turn present on or positioned on a respective directly underlying additional silicon layer, wherein each additional silicon layer has a porosity different from the porosity of the second silicon layer and/or the directly underlying additional silicon layer. According to the invention, porosity of a silicon layer, preferably the optional first layer, the second or additional layer(s), more preferably the optional first layer or the additional layer(s), is preferably determined by electron microscopy.

The at least second silicon layer according to the invention can be a gradient layer, wherein the gradient layer has a first surface and a second surface opposing the first surface, and a porosity that varies with a distance defined from the first surface to a plane parallel to the first surface in the second layer, wherein the maximal distance is a thickness of the gradient layer defined between the first and second surfaces. The additional silicon layer according to the invention can be a gradient layer, wherein the gradient layer has a first surface and a second surface opposing the first surface, and a porosity that varies with a distance defined from the first surface to a plane parallel to the first surface in the additional layer, wherein the maximal distance is a thickness of the gradient layer defined between the first and second surfaces. Preferably, either the first surface or the second surface is facing and in contact with the first silicon layer. Preferably, the porosity varies from a lowest porosity at one of the first and second surfaces to a highest porosity at the other of the first and second surfaces. Preferably, the porosity decreases from one of the first and second surfaces to a value at a point between the first surface and the second surface and increases from the value to the other of the first and second surfaces.

Preferably, the porosity increases from one of the first and second surfaces to a value at a point between the first surface and the second surface and decreases from the value to the other of the first and second surfaces. Preferably, the point is a plane parallel to the first surface or the second surface. Preferably, the point is at a distance of from 5 to 95% of the maximal distance, wherein the maximal distance is a thickness of the gradient layer defined between the first and second surfaces. More preferably the point is at a distance of from 20 to 80% of the maximal distance, more preferably of from 30 or 40 to 60 or 70%. Preferably, the point is at a distance of about 10, 20, 30, 40 or 50% of the maximal distance.

A preferred gradient layer according to the invention is understood to not have a clear demarcation in its layer with regard to porosity when assessed via for example electron microscopy. When a difference in porosity is referred to with regard to different, lower or higher porosities of different silicon layers according to the invention when compared to a silicon layer having a gradient layer, this is understood to be compared to the average porosity of the silicon layer having a gradient layer.

The preferred multilayer configuration of the composite material according to the invention foresees in a stack of silicon layers each having a different porosity from a respective adjacent silicon layer. In such a configuration a first, preferably bottom, surface area of the second silicon layer is in direct contact with the surface area of the optional first silicon layer that is preferably opposite the surface area that is in direct contact with the current collector material layer, and a second, preferably opposite, surface area of the second silicon layer is in direct contact with the first, preferably bottom, surface area of the additional silicon layer. Alternatively, a first, preferably bottom, surface area of the second silicon layer is in direct contact with the surface area of the current collector, and a second, preferably opposite, surface area of the second silicon layer is in direct contact with the first, preferably bottom, surface area of the additional silicon layer.

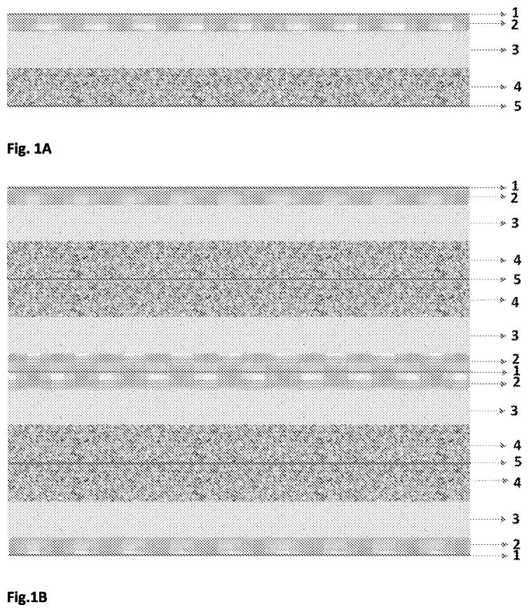

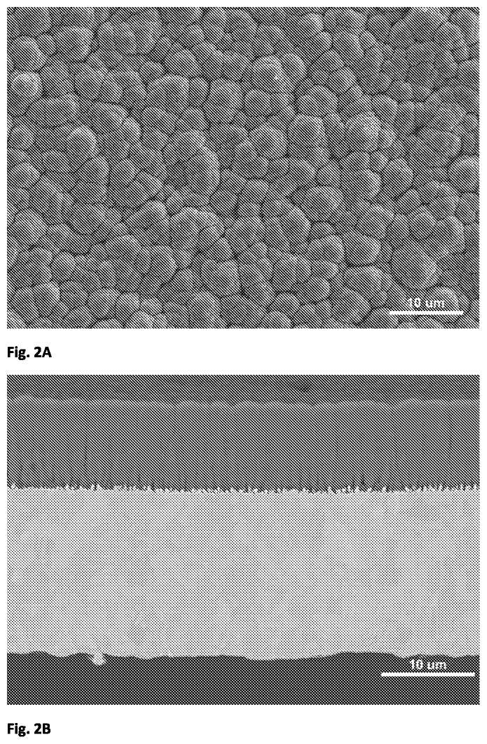

In addition, the first, preferably bottom, surface area of each of the optional one or more additional silicon layers is in direct contact with the second, preferably opposite, surface area of the respective directly underlying additional silicon layer. Examples of multilayer configurations are illustrated in FIG. 1. The composite material according to the invention preferably comprises multiple silicon layers formed such that layers having lower porosities and layers having higher porosities are alternately stacked to one another. The composite material according to the invention preferably comprises, the silicon layer or layers, preferably the optional first layer, the second and/or the additional silicon layers, on only one side of the current collector material or on each of two sides of the current collector material.

Advantageously, the composite material according to the invention preferably comprises the silicon layers having a combined thickness of from 1 to 30 or 50 μm, preferably of from 5 or 10 to 15 or 20 μm or a mass loading of from 0.1 to 4 mg/cm², preferably of from 0.5, 0.8, 1.0, 2.0 to 2.5, 3.5 or 4.0 mg/cm². The combined thickness or the mass loading pertains to the silicon layers that are present on one side of a current collector material layer.

The term “argyrodite solid electrolyte layer” herein refers to argyrodite sulfide-based electrolyte is composed of PS43−, S2−, and halide anions and the lithium cation (e.g. Li7P3S11, Li6PS5Cl, Li6PS5Br, etc.), wherein the layer is formed under pressure.

The term “a mixed cathode” herein refers to a comprising cathode active material, argyrodite sulfide-based powder, and a conductive carbon material with a certain mass ratio. The cathode active material can be one or combination of the lithium nickel manganese cobalt oxide or lithium nickel cobalt aluminium oxides or lithium Manganese Spinel or lithium iron phosphate.

The argyrodite sulfide-based are composed of PS43−, S2−, and halide anions and the lithium cation (e.g. Li7P3S11, Li6PS5Cl, Li6PS5Br, etc.). The conductive carbon materials consist of one or several combinations of carbon black, carbon nano fibre or glassy carbon material.

The anode material, and/or or both anode and cathode materials according to the invention can be successfully be employed in solid-state, or semi-solid electrolyte batteries. The subject battery, and in particular the anode materials also proved useful when a semi-solid state electrolyte without a porous separator disposed between the cathode and the anode was employed, using an anode protecting layer in physical contact with the anode active material layer and comprising of a polymeric material having a fully recoverable tensile elastic strain from 1% to 1000%, and a lithium ion conductivity from 10⁻⁸ S/cm to 5×10⁻² S/cm, when measured at room temperature.

The silicon film according to the invention is preferably designed to be used as an anode for a semi-solid or solid-state battery.

In case of the solid state battery, it preferably comprises (i) a 100% silicon layer composites of amorphous structure, wherein (ii) the porous silicon layer comprises a plurality of columns and nano-sized primary particles in the silicon columns, (iii) a copper current collector where the silicon film is directly deposited on it, (iv) an argyrodite sulfide-based electrolyte layer or pallet, and (v) a cathode mixture comprising one or a combination of cathode active materials of lithium nickel manganese cobalt oxide or lithium nickel cobalt aluminium oxides or lithium manganese spinel or lithium iron phosphate, argyrodite sulfide-base powder, conductive carbon materials.

The silicon layer may advantageously comprise an amorphous structure in which nano-crystalline region may exist. Moreover, according to the present invention the vacancy in the amorphous structure leads to the formation of pores in the structure of 10-40 nm pore sizes in the nano-sized primary particles. The structure comprising a plurality of columns preferably also exhibits a large porosity, preferably in the range of from 10% to a porosity of less than 80%, as determined by electron microscopy.

An advantage of this unique structured silicon anode is that the swelling behaviour of silicon anode can be restricted during electrochemical lithiation.

The silicon anode when used as anode in a lithium-ion battery, preferably comprises a metal or metal alloy, preferably copper, nickel or titanium current collector. Furthermore the silicon layer may preferably have a thickness in the range of from of 1 μm to 30 μm. Furthermore the silicon layer may preferably have a mass loading of 0.25 up to 4.0 mg/cm².

As a result, the specific capacity of silicon anode can reach up to 0.75 mAh/cm² up to 12 mAh/cm².

A particular benefit related to the use of the silicon anode in a solid-state battery according to the invention, a solid electrolyte interface (SEI) will likely only be formed between the silicon layer and the solid argyrodite sulfide-based electrolyte.

Without wishing to be bound to any particular theory, it is believed that the thus formed SEI would act as lithium-ion conductor and electron blocker. Compared to conventional liquid electrolytes, the transportation of lithium ions and the electron pathway was observed to changes from three-dimension (3D) to two-dimension (2D) in the silicon anode based solid state battery. The silicon columns may thereby act as a tunnel to transport the electrons and lithium-ions. Furthermore, no SEI is expected to be formed in the depth of silicon layer since there is no direct contact to the electrolyte. Thus, the lithium-ion loss in the spontaneously formation of new SEI is omitted for silicon anode in a solid-state battery during cycling.

Preferably, the solid-state electrolyte layer (ii) comprises an argyrodite sulfide-based solid electrolyte. Preferably, the silicon composite anode material comprises a silicon film and copper, nickel or titanium current collector.

Preferably, the cathode layer comprises a cathode active material selected from lithium nickel manganese cobalt oxide, lithium nickel cobalt aluminium oxides, lithium Manganese Spinel, lithium iron phosphate; and conductive carbon materials.

Preferably, the silicon composite material is essentially composed solely of silicon, and exhibits an amorphous structure comprising nano-crystalline regions.

Preferably, the silicon layer has a porous silicon structure with a plurality of columns and nano-sized primary particles in the silicon columns.

The silicon columnar structures may be arranged in different forms, typically having a central axis. However, these columnar structures may also be arranged so that an angle is formed between the basal plane and the central axis. Without wishing to be bound by any particular theory, it is believed that this may be the result of a nucleation and subsequent ballistic growth upon deposition of more silicon. Depending on the roughness of the surface of the current collector material, the central axis of these structures may deviate from a strictly perpendicular position with respect to the basal plane. Once such growth is done, this may form in the shape of stacked cones, ice-cream cone shapes, or inversed stacked cone structures. The diameter of the structures may conveniently range of from 10 μm to 200 μm, preferably of from 80 μm to 120 μm, such as 100 μm. Despite these structural variations, the silicon anodes materials are generally suitable for use in the compositions of the present invention.

A stacked cone according to the invention generally comprises an essentially frustoconical body with a cone angle α in the range of from 65° to 85°, preferably of from 70° to 80°, converging from a closed anchoring point at the basal plane, and extending upwardly therefrom. Extending from this tapered portion may be an essentially cylindrical portion, thus forming a columnar structure that is essentially perpendicular to the basal plane, or a convex, dome-shaped end portion having a given radius R, thus forming the “ice-cream” front end, or dendritic structure, pointing away from the basal plane. The average distance from the anchoring point where the structure contacts the basal plane along a longitudinal axis of the base portion to the point mot distal to the basal plane is in the range of from 3 μm to 15 μm. Preferably this average length is in the range of from 4 μm to 10 μm, as estimated from the cross section shown in the SEM images. The macroscopic structure of the silicon columnar structures is advantageously analysed via SEM Imaging. In the top view (FIG. 2A) a very compact columnar morphology is seen, whereby some columns tips appear to be more bulky than others. Preferably, the anode material according to the invention, comprising a double sided physical vapour deposition (PVD), chemical vapour deposition (CVD), pulsed laser deposition (PLD), sputtering, and/or electrochemical spraying-deposited silicon anode on either side of an essentially planar current collector. The frustroconically-shaped structure may extend into an essentially cylindrical portion forming a columnar structure essentially perpendicular to the basal plane; or a convex, dome-shaped end portion having a given radius R, thus forming the “ice-cream” front end, pointing away from the basal plane.

Preferably, the average distance from the anchoring point where the structure contacts the basal plane, along a longitudinal axis of the base portion to the point to distal to the basal plane, is in the range of from 3 μm to 15 μm, preferably in the range of from 4 μm to 10 μm, as estimated from the cross section shown in the SEM images.

The average diameter of a cone, including any columnar portion there upon, is in the range of from 0.5 μm to 15 μm, preferably of from 1.0 μm to 10 μm, based on the widest point of the cone, and averaging measured cones per 10 μm, as determined by SEM microscopy.

The “average length” and “average cone angle” herein refers to the average of counted and measured silicon structures per 10 μm, as determined from SEM microscopic images. Between the frustoconical shaped structures, usually smaller inverted cone-shaped structures are formed, whereby the cone narrows in the direction away from the basal plane. Without wishing to be bound by any particular theory, it is considered that this may be the result that these structures are limited in growth by faster growing adjacent portions.

Without wishing to be bound by any particular theory, it is noted that the presence of such structures appears to improve the stability of the anode material, in particular when undergoing a volume change during lithiation, thereby providing for a more stable solid electrolyte interface, and minimizing electrode fracture over time and under cycling conditions, as the available space between the structures permits expansion and contraction with limited friction pressure built-up between the structure, as compared to e.g. densely packed parallel columnar structures. Accordingly, the present materials according to the invention comprise at least an average of 1 inverted cone or smaller cone per larger cone; more preferably at least 2 to 5 inverted cones or smaller structures per larger cone structure.

Preferably, the porous silicon layer has a porosity in the range of from 5% to 80%, as determined by electron microscopy.

Preferably, the silicon film has been directly deposited onto the current collector, preferably by a plasma-enhanced-chemical-vapour deposition (PECVD) method.

Preferably, the silicon film can be deposited on one or both sides of the current collector.

Preferably, the silicon film has a thickness of 1 μm up to 30 μm, preferably of about 5 μm up to 20 μm. Preferably, the silicon film has a mass loading in the range of from 0.1 up to and including 4.0 mg/cm².

The surface roughness of the current collector appears to play a role herein, whereby a rougher surface, and/or a surface comprising more artefacts appears to promote a less uniform growth, as well as growth into directions that are essentially not perpendicular to the basal plane; whereas a less rough surface or a surface comprising less artefacts appears to result in a more homogeneous formation of parallel columnar silicon structures. This is exemplified by a material according to the present invention, as for instance depicted in FIG. 2B, showing two different surfaces of a copper foil and two slightly different silicon columnar structure morphologies as a result thereof.

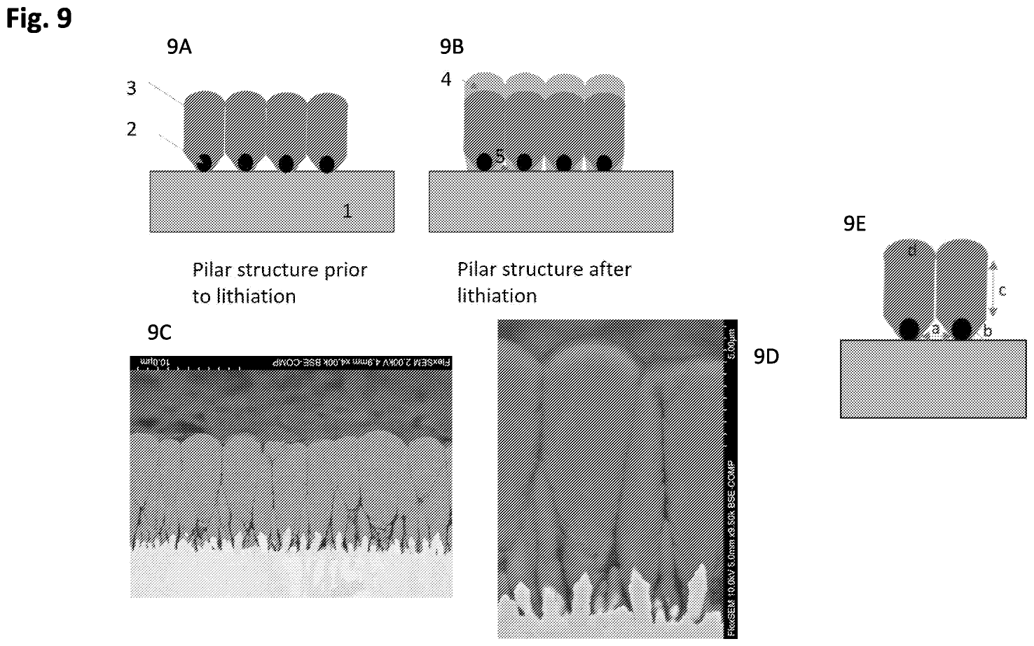

FIGS. 9A and 9B show schematically a silicon anode material according to the invention for use in lithium batteries, including those for solid state electrolyte. Herein, the anode structures are visible before (A), and post lithiation (B). FIGS. 9C and 9D show SEM images showing this effect on actually tested materials. On the current collector basal plane (1), nodules or aggregates are added (2), e.g. a copper foil with copper nodules or aggregates.

The nodules or aggregates are then initiation points for the growth of the silicon columnar structures or pillars (3), in particular when growing those using PECVD techniques. However, in addition to the pure silicon, other chemical contents, e.g. Silicon alloys may be included; and other deposition techniques falling into the scope of this invention may also be applied.

The use of the aggregates or nodules, and more generally, surface roughness at typically specific distances from each other result in an essentially non-perpendicular pillar growth. The pillar sizes can be described by an up-side down cone shape with a part of a sphere on top, e.g. an ice-cream cone or dendritic shape. Herein, the pillar distance at the basal plane interface is larger as compared to the pillar distance at the top of the pillar.

During lithiation in lithium battery applications the silicon anode swells. FIG. 9, at (4) shows the additional volume of the anode caused by swelling. This swelling causes mechanical stresses. The most vulnerable part of the pillar towards mechanical stress is the part near the interface. Mechanical stress near the interface can cause delamination of pillars making the complete pillar in-active. This delamination reduces the lifespan of a lithium battery.

Since the distance between the pillars in this disclosure is larger at the interface the mechanical stress at the interface during lithiation is limited, improving the lifespan of the lithium battery.

FIG. 9E illustrates the distances and sizes of the structures. Herein the distance between the centre of a nodule or columnar structure to the centre of a second nodule or columnar structure is determined on the cross-section. Herein, the average full range is in the range of from 0.25 μm to 1.25 μm, preferably of from 0.75 μm to 1.2 μm. The average gap (a) between nodules is in the range of from 0.1 μm to 1.5 μm.

The angle of initial growth is perpendicular to the basal plane, so a starting average value for b (representing the outer cone angle) is difficult. Where nodules start growth from an artefact on the basal plane, i.e. starting at some point on the side of a structure, the trajectory of growth forming the structures are not essentially perpendicular. At these points the average cone angle may be equal to or larger than 45°, it grows out to the side, but eventually the tapper will change for a more perpendicular direction. Accordingly the average cone angle ß is in the range of from 60° to 85°, such as 65° to 80°.

Preferably, the angle γ at the top end at peak of a nodule or structure, is in the range of from 10° to 90°. The average height of the structures is preferably in the range of from 0.25 μm to 3 μm. Hereby it is noted that the height of pillar is dependent on mass loading, and preferably about 1.5 mg/cm², which corresponds usually to 10 μm of height.

The average radius of a columnar structure or nodule at its widest point is preferably in the range of from 0.125 μm to 1 μm. The average radius a preferably of the dome shaped top of a columnar structure is preferably in the range of from 0.1 μm to 5 μm.

Preferably, the solid-state electrolyte layer comprises sulfide-based solid electrolyte, preferably an electrolyte selected from argyrodite, Li₁₀GeP₂S₁₂ (LGPS), Li₇P₃S₁₁ (LPS); bare and doped Li₇La₃Zr₂O₁₂ (LLZO) garnet structure oxides; halide solid electrolytes, NASICON-type phosphate glass ceramics, preferably (LAGP), oxynitrides, preferably lithium phosphorus oxynitride or LIPON; and polymers, preferably PEO or PVA, or any combination thereof.

Preferably, the cathode layer comprises cathode active material, solid electrolyte, carbon conductive material and a aluminium current collector.

Preferably, the cathode active material comprises lithium cobalt oxide, lithium nickel oxide, lithium nickel manganese cobalt oxide or lithium nickel cobalt aluminium oxides or lithium manganese spinel or lithium iron phosphate. The cathode active material in this claim can be one material, or any combination thereof.

Preferably, a carbon conductive material in cathode layer comprises electronic conductive material, carbon black conductive materials, carbon nanofiber conductive material, carbon nanotube material, glass carbon conductive material or graphene conductive material, or combinations thereof.

The present disclosure also relates to a process for assembling a silicon anode-based solid-state battery, comprising (i) depositing a single- or double-sided silicon film on a current collector, to form the silicon anode material; (ii) providing a solid-state electrolyte layer in contact with the silicon film, and (iii) providing a cathode layer in contact with the solid-state electrolyte layer.

Preferably, step (ii) is performed by compressing a solid-state electrolyte powder onto the silicon anode film, thereby forming a solid-state electrolyte layer, or wherein step (ii) is performed by a film formation method including slurry coating, physical vapour deposition (PVD), chemical vapour deposition (CVD), pulsed laser deposition (PLD), sputtering, and/or electrochemical spraying.

The present invention also relates to the use of a silicon anode comprising an essentially pure amorphous porous silicon film deposited onto a current collector, and comprising a plurality of columnar structures in a solid-state battery.

The present invention furthermore relates to the use of a silicon anode comprising an essentially pure amorphous porous silicon film deposited onto a current collector, and comprising a plurality of columnar structures in a solid-state battery.

The following non-limiting examples illustrate the invention.

### EXAMPLES

Solid batteries were produced as set out herein below, preparing the negative electrode, and the positive electrode mixture, and an evaluation of the battery characteristics was carried out.

### Silicon Anode:

A silicon layer was deposited on one side of a copper foil by PECVD, thereby generating anode silicon electrode materials. The composite electrode material was manufactured as follows: A roll of copper foil current collector material was fed into a deposition device that comprises an unwinding chamber, two deposition chambers and a rewinding chamber. These chambers are all connected and are normally operated under vacuum (0.05-0.2 mbar). The foil was transported by a system of tension rolls and two heated drums that will control the temperature of the foil. A first and at least a second silicon layer were deposited onto the substrate by plasma enhanced chemical vapor deposition, at a substrate temperature of from 100 to 300° C. In this process magnetron radiation with a frequency of 2.45 GHz was used to excite a gas mixture containing a silicon precursor gas and support gases. Silane (SiH4) was the source of silicon, whereas argon (Ar) and hydrogen (H2) were added to stabilize the plasma, influence the material structure and improve the deposition rate. The gas was injected via “gas showers” that distribute the gas evenly. The magnetron radiation was introduced into the vacuum chamber by means of an antenna. To make the plasma homogeneous, both sides of the antenna are connected to a magnetron radiation source. Magnetron heads are thus located on each side. These magnetron heads are connected to the antenna. Gases are injected via the gas showers between the magnetron heads. The antenna is protected from the reactive environment by a quartz tube. The plasma is confined by a magnetic field that is generated by an array of permanent magnets. The production rate of silicon was determined by the process conditions, power input per source, and by the number of microwave sources in operation. The gas flow was scaled with the MW power input, which was 800-6000 W/m. Ten antennas or sources of power input were used. FIGS. 2A and 2B show an example of the top and the cross-section SEM images of the single-sided deposited silicon anode prepared in this manner. FIG. 2C shows an example of the cross-section SEM images of a double-sided deposited silicon anode. Of note in all figures are the columnar structures, which may include essentially parallel columnar structures, but also may be arranged so that an angle is formed between the basal plane and the columnar central axis. Such shapes are typically also referred to as stacked cones, ice cream cones, or stacked cone structures. The diameter of the as stacked cones, and/or ice cream cones can range of from 1 to 10 μm.

### Cathode Material

A positive electrode mixture powder was prepared by mixing the active material powder, solid electrolyte powder, and a conduction supporting agent powder in a ball mill.

### Example 2: Formation of the Solid State Battery

On top of the silicon anode material, a 2 μm thick layer of the solid electrolyte argyrodite sulfide based Li₆PS₅Cl as solid electrolyte layer was deposited. For the formation of the cathode, a paste of spherical particles and a suitable binder was formed and pasted on top of the solid electrolyte. An indium foil was placed on top of the cathode to enclose the cell. The above example formed a battery structure illustrated in FIG. 1.

### Example 3: Performance of the Solid State Battery

The performance of the cell was tested, and FIGS. 3A, B, C, and D shows three examples of the electrochemical rate performance of a single side silicon anode with different mass loading in an solid-state half-cell, wherein an argyrodite sulfide based Li₆PS₅Cl is used as solid electrolyte layer, and the lithium and indium metal foil are used as counter electrodes. In these FIGS. 3A, B, C, and D, the rate performance is illustrated of Si anodes with different mass loading, and 1C rate is defined as 3000 mAh/g based on Si mass. Indium metal was used to avoid or reduce to parasitic reaction between lithium metal and solid electrolyte Li₆PS₅Cl. The solid-state half-cell was tested to verify the feasibility of the silicon structure as an anode in this solid-state battery. In the examples of the solid-state battery shown, the argyrodite sulfide based Li₆PS₅Cl was used as solid electrolyte layer.

The results illustrate that a battery using a the silicon anode according to the invention performed exceedingly well, showing an excellent lithium-ion host ability in solid-state battery.

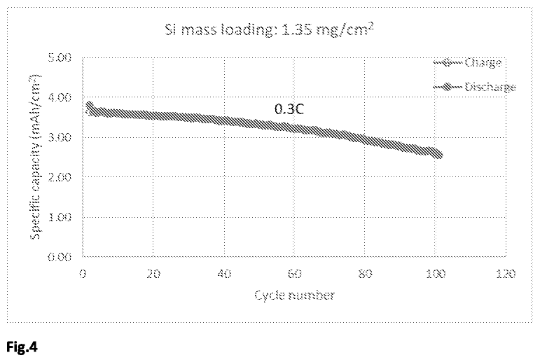

FIG. 4 shows an example of the electrochemical cycle performance of a single side silicon anode in an solid-state half-cell, where the argyrodite sulfide based Li₆PS₅Cl is used as solid electrolyte layer, and the lithium and indium metal foil are used as counter electrodes.

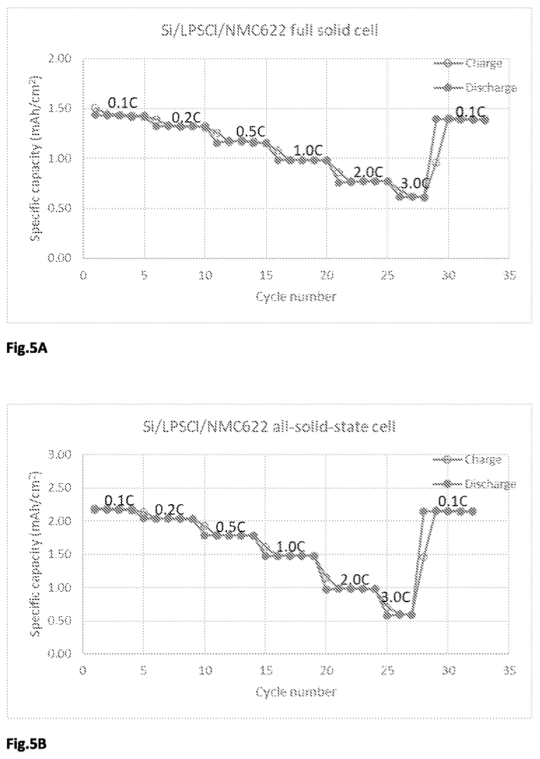

FIGS. 5A and B shows two examples of the electrochemical rate performance of a single side silicon anode in a solid-state batteries, where the argyrodite sulfide based Li₆PS₅Cl is used as solid electrolyte layer, and the lithium nickel manganese cobalt oxide mixture (LiNi_{0.6}Mn_{0.2}Co_{0.2}O₂, NMC622 cathode active powder mixed with Li₆PS₅Cl, and conductive carbon powder) is used as cathode.

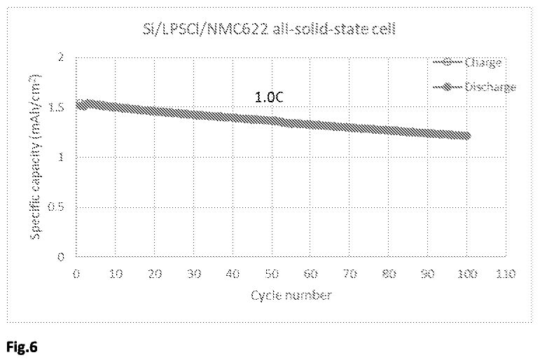

FIG. 6 shows an example of the electrochemical cycle performance of a single side silicon anode according to the invention in solid-state batteries, where the argyrodite sulfide based Li₆PS₅Cl was used as solid electrolyte layer, and a lithium nickel manganese cobalt oxide mixture (LiNi_{0.6}Mn_{0.2}Co_{0.2}O₂, NMC622) cathode active particulate material was mixed with Li₆PS₅Cl, and conductive carbon powder was used as cathode material.

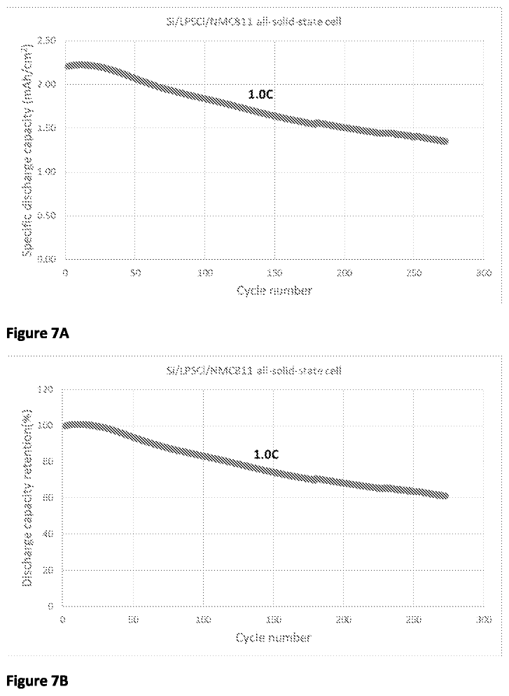

FIG. 7 shows an example of the electrochemistry cycle performance of a single sided silicon anode according to the invention in the solid-state battery, wherein the argyrodite sulfide based Li₆PS₅Cl is used as solid electrolyte layer, and a lithium niobium oxide (LiNbO₃) coated lithium nickel manganese cobalt oxide (LiNbO₃ coated LiNi_{0.8}Mn_{0.1}Co_{0.1}O₂, NMC811 cathode active powder) was mixed with Li₆PS₅Cl power is used as cathode, and LiOH-treated LiNbO₃-coated NMC811, mixed with Li₆PSCl₅ in a mass proportion of 70:30 wt. % was used as the cathode.

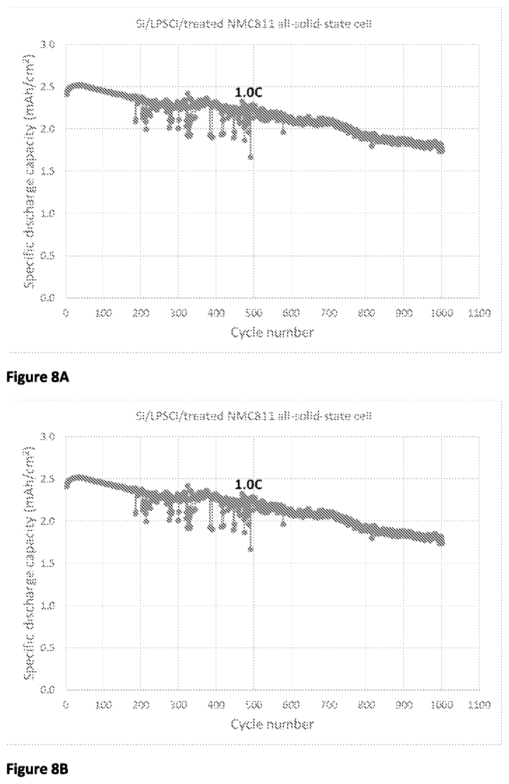

FIG. 8 shows an example of the electrochemistry cycle performance of a single-sided silicon anode according to the invention in the solid-state batteries. Herein, as the cathode active material LiNbO₃-coated NMC811 material was further treated by using LiOH, by simply grinding and mixing LiOH powder and NMC811 powder in a certain mass proportion, and then the mixture is further annealed at certain temperature in air. In this example, the mass proportion of LiOH:LiNbO₃-coated NMC811 was 5:95 wt. %, afterwards the mixture was annealed at 750° C. for 10 hours in contact with air.

As described above, according to the exemplary embodiments of the present invention, the solid-state battery containing the inorganic nano-solid electrolyte has substantially improved battery performance as well as excellent safety, and may be widely used and contribute to development of industry such as electric vehicles, or the like, in which middle and large lithium ion rechargeable batteries are used.

Although the present invention has been described with reference to exemplary embodiments and the accompanying drawings, the present invention is not limited thereto, but may be variously modified and altered by those skilled in the art to which the present invention pertains without departing from the scope of the present invention claimed in the following claims. Further modifications and alternative embodiments of various aspects will be apparent to those skilled in the art in view of this description. Accordingly, this description is to be construed as illustrative only. It is to be understood that the forms shown and described herein are to be taken as examples of embodiments. Elements and materials may be substituted for those illustrated and described herein, parts and processes may be reversed, and certain features may be utilized independently, all as would be apparent to one skilled in the art after having the benefit of this description. Changes may be made in the elements described herein without departing from the spirit and scope as described in the following claims.

1. A lithium-ion battery, comprising:
a silicon anode comprising an essentially pure amorphous porous silicon film deposited onto a current collector, and comprising a plurality of columnar structures;
an electrolyte layer comprising one or more solid components, and
a cathode layer.

2. The battery according to claim 1, wherein the electrolyte layer comprises an argyrodite sulfide-based electrolyte.

3. The battery according to claim 1, wherein the silicon anode material comprises a silicon film and copper, nickel or titanium current collector.

4. The battery according to claim 1, wherein the cathode layer comprises a cathode active material selected from lithium nickel manganese cobalt oxide, lithium nickel cobalt aluminium oxides, lithium Manganese Spinel, a lithium transition metal oxide, lithium iron phosphate, or a combination thereof; and conductive carbon materials.

5. The battery according to claim 1, wherein the silicon anode material is essentially composed solely of silicon, and exhibits an amorphous structure comprising nano-crystalline regions.

6. The battery according to claim 1, wherein the silicon anode material has a porous silicon structure with a plurality of columns and nano-sized primary particles in the silicon columns.

7. The battery according to claim 6, wherein the silicon layer has a porosity in the range of from 5% to 80%, as determined by the PECVD deposition condition.

8. The battery according to claim 1, wherein the silicon film has been directly deposited onto the current collector, preferably by a plasma-enhanced-chemical-vapour deposition (PECVD) method.

9. The battery according to claim 8, wherein the silicon film has been deposited by a physical vapour deposition (PVD) method, such as by a plasma-enhanced-chemical-vapour deposition (PECVD) method, chemical vapour deposition (CVD) method, pulsed laser deposition (PLD) method, sputtering, and/or electrochemical spraying method.

10. The battery according to claim 1, wherein the silicon film can be deposited on one or both sides of the current collector.

11. The battery according to claim 1, wherein the silicon film has a thickness of 1 μm up to 30 μm,

12. The battery according to claim 1, wherein the silicon film has a thickness of about 5 μm up to 20μ, and/or a mass loading of 0.1 up to 4.0 mg/cm².

13. The battery according to claim 1, wherein the electrolyte layer comprises sulfide-based electrolyte, preferably an electrolyte selected from argyrodite, Li₁₀GeP₂S₁₂ (LGPS), Li₇P₃S₁₁ (LPS), bare and doped Li₇La₃Zr₂O₁₂ (LLZO) garnet structure oxides, halide electrolytes, NASICON-type phosphate glass ceramics, preferably (LAGP), oxynitrides; and polymers.

14. The battery according to claim 1, wherein the cathode layer comprises a cathode active material, solid electrolyte powder, carbon conductive material and an aluminium current collector.

15. The battery according to claim 13, wherein the cathode active material comprises lithium cobalt oxide, lithium nickel oxide, lithium nickel manganese cobalt oxide, lithium nickel cobalt aluminium oxides, lithium manganese spinel, lithium iron phosphate, or a combination thereof.

16. The battery according to claim 14, wherein a carbon conductive material in cathode layer comprises electronic conductive material, carbon black conductive material, carbon nanofiber conductive material, carbon nanotube material, glass carbon conductive material or graphene conductive material, or combinations thereof.

17. The battery according to claim 13, wherein the cathode material comprises particulate LiNbO₃ coated LiNi_{0.8}Mn_{0.1}Co_{0.1}O₂ (NMC811) material blended with Li₆PS₅Cl particulate material, in a mass ratio of NMC811:Li₆PS₅Cl in the range of from 90:10 to 60:40.

18. The battery according to claim 17, wherein the cathode LiNbO₃-coated LiNi_{0.8}Mn_{0.1}Co_{0.1}O₂ (NMC811) material is further blended under comminuting with LiOH, and then the mixture is annealed in the presence of air.

19. The battery according to claim 18, wherein the proportion of LiOH:LiNbO₃-coated NMC811 is in the range of from 1:99 to 10:90 wt. %.

20. The battery according to claim 18, wherein the blended cathode material is annealed at a temperature in the range of from 700° C. to 800° C., for a period in the range of from 1 to 20 hours, in the presence of air.

21. The battery according to claim 18, wherein argyrodite sulfide based Li₆PS₅Cl represents the solid electrolyte layer, and wherein LiNbO₃-coated LiNi_{0.8}Mn_{0.1}Co_{0.1}O₂ (NMC811) material is blended with Li₆PS₅Cl in a mass ratio in of about 70:30 wt. % is used as the cathode material.

22. A process for assembling a silicon anode-based solid-state battery, comprising
(i) depositing a single- or double-sided silicon film on a current collector, to form the silicon anode material;
(ii) providing an electrolyte layer in contact with the silicon film, and
(iii) providing a cathode layer in contact with the electrolyte layer.

23. The process according to claim 22, wherein step (ii) is performed by compressing an electrolyte powder onto the silicon anode film, thereby forming the solid-state electrolyte layer, or wherein step (ii) is performed by a film formation method including slurry coating, physical vapour deposition (PVD), chemical vapour deposition (CVD), pulsed laser deposition (PLD), sputtering, and/or electrochemical spraying.

24. (canceled)

25. An anode material for use in a battery, comprising (i) a silicon anode comprising an essentially pure amorphous porous silicon film deposited onto a current collector, and comprising a plurality of columnar structures;
wherein the plurality of columnar structures are frustoconical shaped structures having an average cone angle α in the range of from 60° to 85°, converging from a closed anchoring point at the basal plane, and extending upwardly therefrom.

26. The anode material according to claim 25, comprising a double sided silicon anode material deposited by physical vapour deposition (PVD), chemical vapour deposition (CVD), pulsed laser deposition (PLD), sputtering, and/or electrochemical spraying on either side of an essentially planar current collector.

27. The anode material according to claim 25, wherein the frustoconical-shaped structures extend into an essentially cylindrical portion forming a columnar structure essentially perpendicular to the basal plane.

28. The anode material according to claim 25, wherein the frustoconical-shaped structures extend into an essentially convex, dome-shaped end portion having a given radius R, thus forming an “ice-cream” front end, pointing away from the basal plane.

29. The anode according to claim 25, wherein the average distance from the anchoring point where the structure contacts the basal plane, along a longitudinal axis of the base portion to the point to distal to the basal plane, is in the range of from 3 μm to 15 μm, as estimated from the cross section shown in the SEM images.

30. The anode according to claim 25, wherein the average diameter of the cone, or of a columnar portion there upon which corresponds to the radius of the columnar portion is in the range of from 0.5 μm to 15 μm, based on the widest point of the cone, and averaging measured cones per 10 μm, as determined by SEM microscopy.

31. A rechargeable lithium ion battery comprising an anode material according to claim 25.
